(19) United States
(12) Patent Application Publication
(10) Pub. No.: US 2026/0196144 A1
(43) Pub. Date: Jul. 9, 2026

(54) COMPUTERIZED SYSTEM AND METHOD FOR INTERACTIVE READING ASSIGNMENT, PROGRESS TRACKING AND ASSESSMENT

(71) Applicant: EYES ON PAGES INC., SEATTLE, WA (US)

(72) Inventor: CHANDLER W. SYMMES, SEATTLE, WA (US)

(73) Assignee: EYES ON PAGES INC., SEATTLE, WA (US)

(21) Appl. No.: 19/425,198

(22) Filed: Dec. 18, 2025

Related U.S. Application Data
(60) Provisional application No. 63/736,092, filed on Dec. 19, 2024.

(51) Int. Cl. G09B 7/06; G10L 15/08

(52) U.S. Cl. CPC G09B 7/06; G10L 15/08

(57) ABSTRACT

A computerized system and method for interactive reading tracking and assessment including a user device that records a user reading an assigned text aloud, and a reading assessment tool that can analyze the recording and assess the user's reading ability and progress based on comparisons with expected results. A teacher or instructor may also assign text(s) and review the recordings and assessments through an administrator device connected to the reading assessment tool.

### PRIORITY

This Application claims priority from U.S. Provisional patent application No. 63/736,092 filed on Dec. 19, 2024

### FIELD OF THE INVENTION

The present invention relates generally to improving reading skills, and more particularly, to a system and method which allows an instructor to assign reading to one or more students, to precisely track the completion of these reading assignments, to assess each student's comprehension of the reading, and to determine each student's overall reading fluency.

### BACKGROUND INFORMATION

The 2024 Nation's Report Card indicated that 69% of US 4th graders and 70% of US 8th graders are not proficient in reading. The US ranks 36th in the world in literacy. Many underperforming students know how to read, but they rarely practice, especially in grades 4 and up, since they are highly distracted by their phones and other digital media.

Moreover, it is difficult for teachers to force reading and monitor a student's completion of reading assignments. Daily, structured reading, optimally in print books, is essential for the development of the skills needed for academic and professional success. Across the US, we are sending millions of students to high school without the skills they need to succeed. Many teachers assign reading, but there is currently no system or method for teachers to assign any book or text of his or her choice, and to precisely track each student's completion and comprehension.

The prior art computer programs that aim to assess and improve a user's reading skills are well known. These programs, however, typically only work with proprietary, canned, abridged, or limited reading content, and cannot accurately assess a user's ability to read an unrestricted array of literature and other subject-area texts. In addition, while prior art systems may support some print reading, this is typically done in conjunction with content hosted on computers or tablets. The student's attention is split between the screen and the book, and the practice of genuine reading skills is limited.

Accordingly, a need exists for a new technology that allows teachers to assign daily, structured reading in print books or e-reader devices, to conveniently and accurately monitor each student's progress, and to efficiently identify and diagnose struggling readers on an on-going basis, rather than just with periodic standardized tests.

### SUMMARY OF THE INVENTION

The present invention features systems and methods for directing and assessing students reading in print books or on e-reader devices. The system may include a voice recorder, a headband-mounted camera, smart glasses, proprietary software including AI technology, a user-customizable reading library stored in a database, a user interface that prompts the student to read for a certain amount of time each day, a user interface that reminds the student of exactly where he/she left off in the previous reading session, a system that precisely tracks the student's location and progress in the text, a user interface that periodically delivers AI-generated comprehension and vocabulary quizzes, a system that evaluates the accuracy of the student's quiz answers, and a system that posts the user's reading performance data to a web-based teacher dashboard.

In one embodiment, the student logs into the Eyes on Pages app running on available technology like a laptop, smart phone, Alexa® device or the like. The app displays or speaks the day's assignment, including the student's current location in the text if needed, and instructs him or her to begin reading. While the student is reading, the device displays only the book title and a timer; it does not assist nor collaborate in the reading process in any way.

After a certain amount of time, the app prompts the student to read aloud from his or her current place in the text. Using AI, the app uses the voice recording to precisely bookmark the student's location in the reading. Based on this location, the app then delivers, either by audio or screen, a quiz to assess the student's comprehension and vocabulary. The quiz questions are automatically generated by AI and reference the pages the student has just read in the current session.

If the student scores 100% on the quiz, the app provides the option to start another reading session or to log out. If the student scores below 100% on the quiz, the app provides the option to accept the score or re-read from the session start point and retake the quiz. The app also informs the student that the next quiz may have different questions.

The app uploads the student's reading data to the teacher dashboard on the web. Using this dashboard, the teacher can track each student's progress and reading performance. Examples of posted data include, but are not limited to: Current Location in the text; Reading Stamina (the average reading minutes per session); Reading Velocity (words per minute); Comprehension (average on comprehension quizzes); Vocabulary (average on vocabulary quizzes), and Expression—(gauged from the student's read-aloud recordings). These metrics are compiled into a running Reading Fluency score for each student. All data can be viewed per book or over any number of completed books in each student's reading history.

In another embodiment, the system uses a camera headband or smart glasses and a computer or smartphone running the Eyes on Pages app. The headband or glasses may include a compact close-range camera, small spotlights to illuminate the book, and a rechargeable battery. The computer or smartphone processes camera data from the headband or glasses and performs administrative tasks only. It does not assist nor collaborate in the reading process.

In this embodiment, the student, wearing the headband or glasses, logs into the Eyes on Pages app. The app connects with the headband or glasses and prompts the student to direct his or her eyes to the open book. The camera data is processed by AI to instantly recognize the book and the student's location in the text. If the location is different from where the student ended the previous reading session, the app sounds a tone and posts a location reminder on the screen. Once the student is looking at the correct page in the book, the screen goes blank except for the book title and a timer. The timer counts down the reading session; however, it automatically pauses if the student looks away from the book.

When the timer runs out, the computer sounds a tone and prompts the student to complete a comprehension and vocabulary quiz on the screen. The quiz and follow-up steps function the same as described in the previous embodiment.

In another embodiment, the Eyes on Pages reading headband or glasses include a microchip, headphones, and a microphone which perform some of the tasks done by the computer or smartphone in the previous embodiments. These tasks include, but are not limited to, text recognition and communication with the AI system.

In another embodiment, the system references a dynamic, user-customizable reading library stored in a database. The library of books and reading materials utilized by the system according to the present invention may include titles from the Gutenberg Library that are in the public domain and free to use. In another embodiment, titles may be licensed for use in and with the system. Files may be loaded into the system as text files, HTML files, PDF files or the like.

The loaded files are parsed into sentences and sentences located or mapped within the paragraphs and bookmarked as such. The book or reading material text is loaded into the system and text/sentences/paragraphs are mapped. As the reader reads aloud or uses the headband or glasses camera, the system can thus determine the student's exact location in the book or reading material.

In other preferred embodiments, a web-based dashboard can be reviewed by a third party, such as a teacher or administrator, to review a student's reading performance metrics on the current assignment or over multiple assignments. The dashboard may also include the functions to listen to captured audio, to add or remove books or reading passages to/from the library, to assign or adjust a reading curriculum, and to interact with the user to provide, for example, feedback, assignments, tests, or resources.

The goal of the system is to allow the teacher to set reasonable reading goals and to ask each student to read daily with success, comprehension, and accountability. The present invention uses the convenience, reach, and availability of technology to get students back into books.

It is important to note that the present invention is not intended to be limited to a system or method which must satisfy one or more of any stated objects or features of the invention. It is also important to note that the present invention is not limited to the preferred, exemplary, or primary embodiment(s) described herein.

Modifications and substitutions by one of ordinary skill in the art are considered to be within the scope of the present invention, which is not to be limited except by the allowed claims and their equivalents.

### BRIEF DESCRIPTION OF THE DRAWINGS

These and other features and advantages of the present invention will be better understood by reading the following detailed description, taken together with the drawings wherein:

FIG. 1 is a block diagram of the system according to one aspect of the present invention;

FIGS. 2A and 2B are representations of users interacting with user devices according to two aspects of the present invention;

FIGS. 3A and 3B are representations of a user devices displaying user interfaces according to two aspects of the present invention;

FIG. 4 is a representation of the administrative interface for the present invention; and

FIG. 5 is a flow chart illustrating one exemplary method according to an aspect of the present invention.

### DETAILED DESCRIPTION OF THE PREFERRED EMBODIMENTS

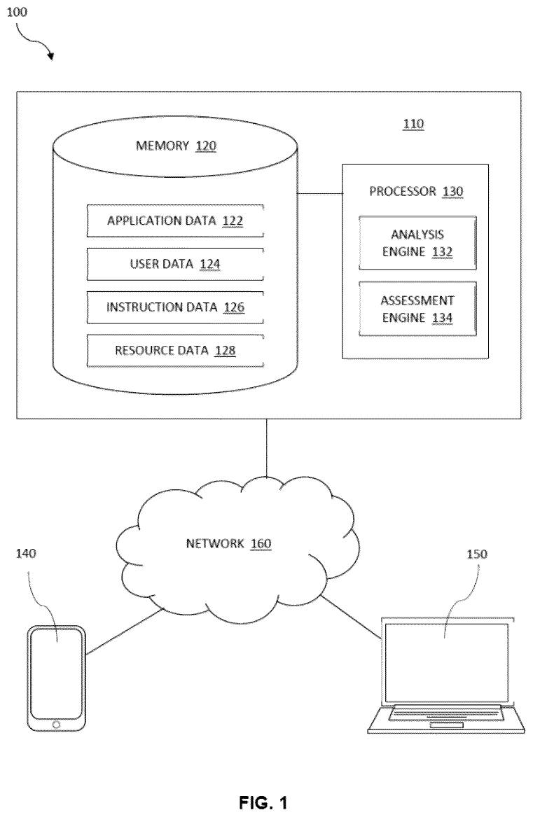

The system 100, FIG. 1, according to some embodiments of the present invention, provides a reading assessment tool 110 that includes a database 120 containing data that is processed by a processor 130. In some embodiments, database 120 includes application data 122, user data 124, instruction data 126, and resource data 128. The system 100 also includes one or more user devices 140 that communicate with the reading assessment tool 110 over a network 160 to receive application data 122 and provide user data 124. User data 124 received from the user device 140 is processed by an analysis engine 132 to provide analyzed user data to an assessment engine 134. The assessment engine 134 processes the analyzed user data 124 to provide assessed user data that provides an actionable assessment of the user's reading ability.

The analyzed user data and assessed user data is stored as part of the user data 124 in the database 120 in some embodiments, or each can be stored separately in other embodiments. Additionally, database 120 can be a single database stored in a central location, or can have separate components stored in distributed databases.

In some embodiments, the system also includes one or more administrator devices 150 that communicate with the reading assessment tool 110 over network 160 to receive application data 122 and provide instruction data 124.

Application data 122 includes information that allows an application to run on one or more user devices 140 and one or more administrator devices 150, if used.

User data 124 is collected through use of assessment tool 110 via the user device 140, as well as through processing of the collected data with the analysis engine 132 and assessment engine 134. User data 124 can include recorded audio entries, responses to AI-generated comprehension quizzes, recorded written entries, and recorded visual entries.

User data 124 also includes time stamps of recordings, information regarding where in a text a user stopped a recording session, duration of recordings, indications of audio other than text recital, or any other information able to be captured by the user device 140 that is valuable or relevant to the skills assessment of the user.

Instruction data 126 includes curriculum, assignments, notes, authorized administrator information, and written, audio and visual resources for instruction.

Resource data 128 includes information about the text that is read by a user, phonetic profiles associated with words used in the text, algorithms used to compare recorded user data to phonetic profiles, vocabulary information (pronunciations, definitions, synonyms, antonyms, example uses, etc.), grammar information, accent information, and any other information that is used as a baseline for comparing captured or processed user data 124 to arrive at an assessment of the user's reading skills. Resource data 128 is stored in the database 120 in some embodiments, or remotely accessed by the reading assessment tool via network 160 in other embodiments.

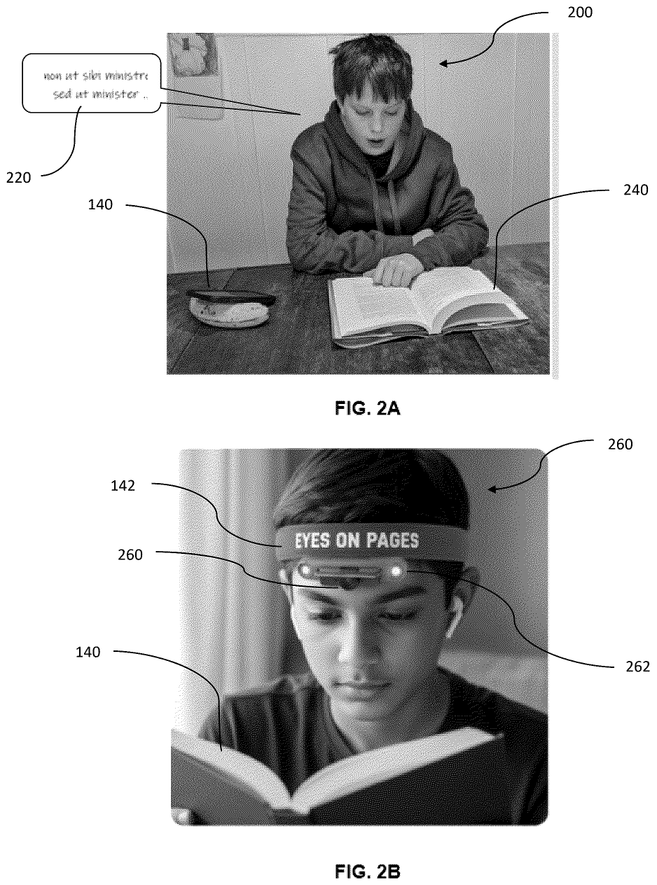

FIG. 2A represents a user 200 interacting with user device 140 such as a cell phone, computer, smart device, or voice recorder such as an Alexa® type device, by reading a book 240 aloud. The user device 140 can be any typical computing device known in the art that includes a microphone, optionally a display, a processor, memory and a network connection.

In some embodiments of the present invention, a microphone connected to or integrated with the user device 140 is utilized to allow audio of the student 200 reading selected portions of assigned book 240 to be recorded while the student is reading aloud and stored in the database 120 with the user data 126.

When interacting with the reading assessment tool 110 through user device 140, the user reads aloud from a text, which can be a physical text such as a book 240 or other a digital text either on the user device 140 or on another device such as an e-reader, laptop, or tablet. The user device 140 then captures the spoken word 220 and stores the recording as user data 124 in the database 120 for analysis by further review by the reading assessment tool 110 or an instructor or teacher.

In one embodiment, the recorded spoken word 220 from the student 200 is compared with the selected text of the book 240 that the student was assigned to read to assess whether what the student is reading is indeed what was in the text assigned. In addition, this recorded information can also be used to be sure that it is indeed the student reading the text and not some other person or electronic device.

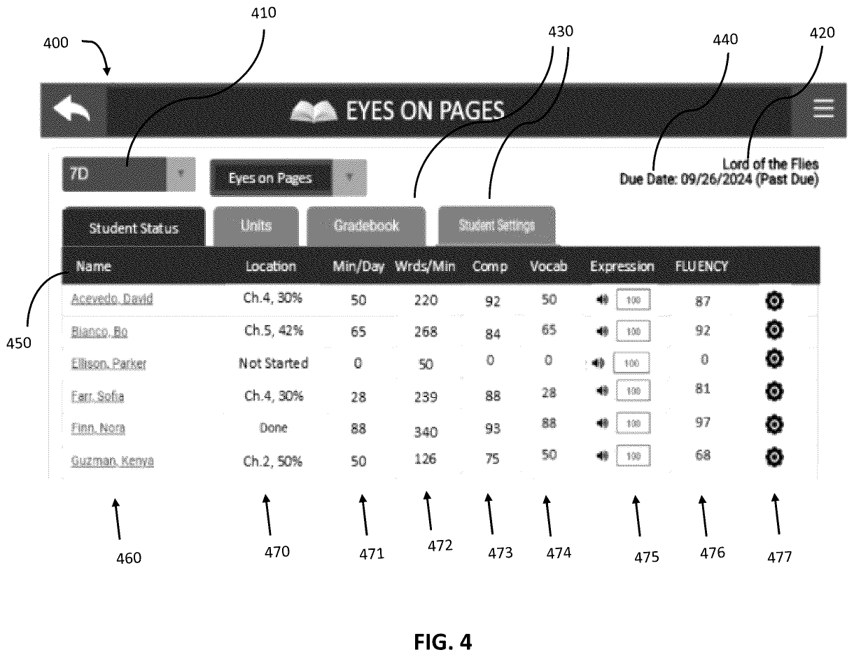

In another embodiment, the teacher may activate the option for the student to read silently. In this case, the device 140 will periodically prompt the user to read aloud from his or her current place in the text. The system will then update the user's location in the text, for display on the teacher's dashboard (FIG. 4, 400).

At this point, the system may also give the user a comprehension quiz on the plot details revealed in the text since the last quiz. The quiz will be generated automatically by artificial intelligence. If the user scores poorly on the quiz, the system may provide the correct answers, give the student the option to accept the score, or ask the student to re-read these pages and retake the quiz. Quiz scores will be averaged as a running comprehension score, and displayed on the teacher's dashboard (FIG. 4, 473).

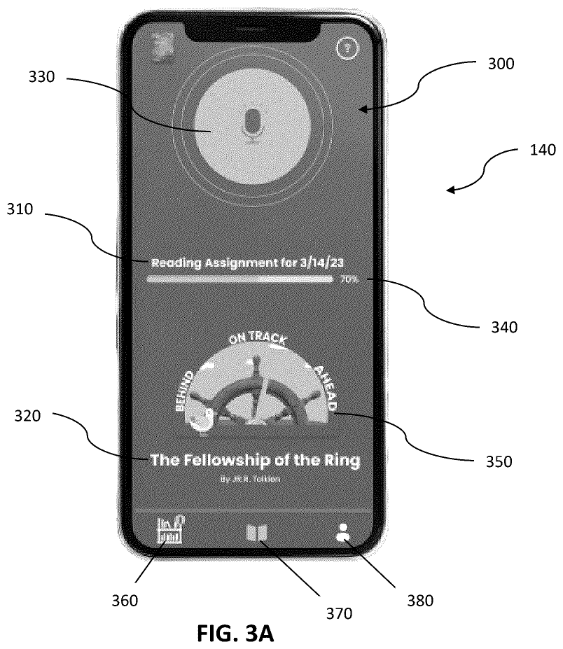

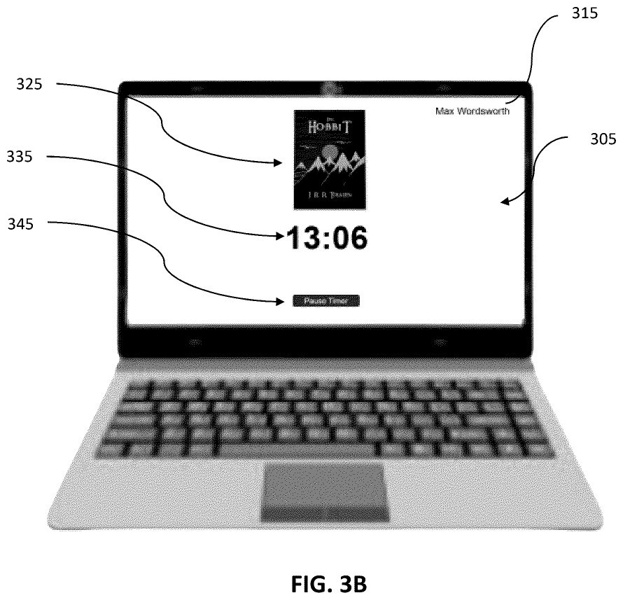

FIG. 2B represents a student wearing a user device 260 such as a headband-mounted camera or smart glasses with a front-facing camera. In this embodiment, the user's focus on the text is precisely recorded by the camera. Through interaction with the app running on the user's smartphone (FIG. 3A, 300) or computer (FIG. 3B, 305), the camera data is stored in the database 120 with the user data 124. If the student looks away from the book, the session timer is paused. The camera data is then converted to text, compared with the current reading assignment, and used to determine the student's location and progress in the book.

FIG. 3A is a representation of a user device 140 displaying a user interface 300 according to an aspect of the present invention. User interface 300 may include an indication of an assignment 310, a text identifier 320 such as a book title, a recording button 330 that can be interacted with to begin and stop recordings and provide an indication that audio is being recorded, a progress indicator 340 to show how far along a user is in completing an assigned reading task, and an assessment indicator 350 indicating how well a recorded passage aligns with an expected metric, such as pace and/or accuracy in reading the text.

The user interface 300 may also include in some embodiments icons that lead to other screens showing, for example, a library of texts 360, a digital version of the assigned task 370, and a user dashboard 380. The user interface may also be a smart-home device without a screen, such as an Alexa® device.

FIG. 3B represents an alternative embodiment to FIG. 3A. In this embodiment, the device 305 displays the student's name 315, the title of the book 325, the reading session timer 335, and a timer pause button 345. In other modes, once the timed reading session has ended, the app running on device 305 may display multiple-choice quiz questions, scores, and other functions.

FIG. 4 is a representation of an administrator interface 400 displayed on an administrator device 150 according to an aspect of the present invention. Administrator interface 400 may include an indication of a class 410, a text identifier 420 such as a book title, tabs 430 that contain various student and administrator data, such as student information, units, gradebooks, and student settings. In the example shown in FIG. 4, the active tab 430 displays a table of student reading information 450 for a listing of students 460 working on assignment 420.

Reading information 450 includes, in this example, a chapter location 470, minutes per day 471 of reading, words per minute 472, comprehension score average 473, vocabulary score average 474, expression average 475, and the calculated overall reading fluency score 476, which allows teachers and administrators to observe each student's reading proficiency at a granular level throughout the year. With this information, teachers and administrators can adjust expectations or provide additional assistance with great precision. The final column, 477, provides settings for the teacher to individualize requirements for each student, for example the reading minutes per day, based on each student's unique abilities.

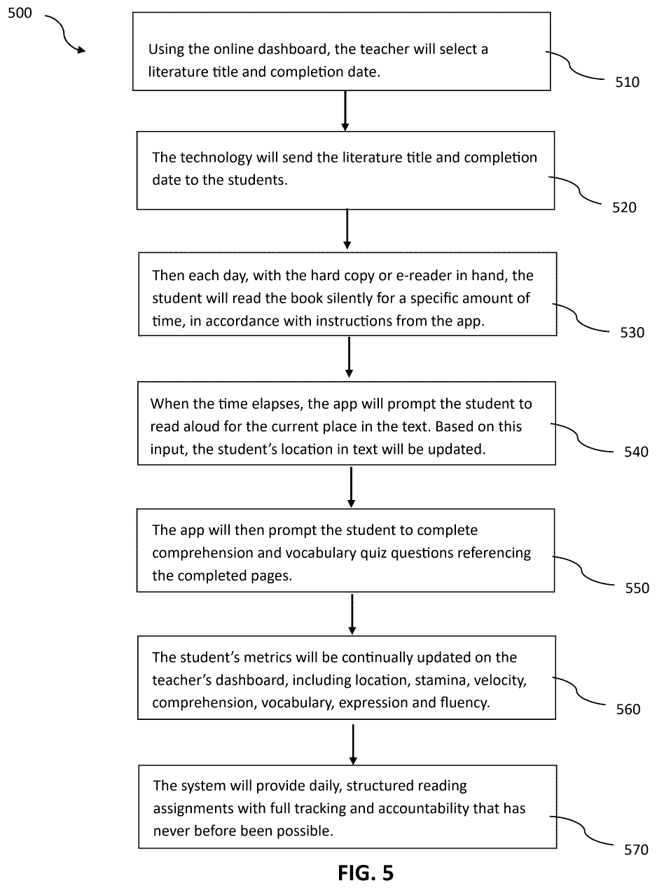

FIG. 5 illustrates a method 500 of assessing a user's reading skill level. In some embodiments, a teacher or administrator may initiate the process with an initial act 510 of selecting a literature title 320 having a digital representation in the resource data 128, and a completion date for a reading task associated with that title, from an online dashboard on an administrator device 150. The system will then automatically push the literature title and completion date out to one or more users.

Then each day (represented at step 530), with a hard copy or digital copy of the selected title 310 in hand, the user will read silently for a set amount of time in accordance with instructions from the reading application.

When the time elapses, (step 540) the app will prompt the student to read aloud from his or her current location in the text. Based on this input, the student's location will updated in User Data 124.

Next, (step 550) the Assessment Engine 134, using AI, will automatically generate comprehension and vocabulary quiz questions for the student to complete using such devices as 300 of 305. The quiz questions will reference the pages the student has most recently read or read in a previous session.

Next (step 560) the reading assessment tool 110 will analyze with the analysis engine 132 the collected user data 124 and assess with the assessment engine 134 the collected user data 124 against resource data 128, and store the assessed user data with the user data 124. The reading assessment tool 110 will then update the metrics displayed on the interface 150 so that teachers and administrators can easily access the latest reading performance metrics on each student.

These metrics may include, but not be limited to: Current Location in the text; Reading Stamina (the average reading minutes per session); Reading Velocity (words per minute); Comprehension (average on comprehension quizzes); Vocabulary (average on vocabulary quizzes), and Expression—(gauged from the student's read-aloud recordings; and overall Reading Fluency—(calculated by Analysis Engine 132).

In step 570, the reading assessment tool 110 will provide daily, structured reading assignments with full accountability based on current user performance. Further the reading assessment tool 110 will generate data that is far more actionable than periodic standardized test results. Students will be measured against grade-level reading proficiency standards throughout the year; teachers and administrators will have many more options to prevent struggling reader from falling through the cracks

Accordingly, the present invention provides novel systems and methods for interactive reading assessment.

It is important to note that the present invention is not intended to be limited to a device or method which must satisfy one or more of any stated or implied objects, embodiments or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by any allowed claims which may flow from this application and their equivalents.

The invention claimed is:

1. A method for assessing a user's reading ability, the method comprising:
utilizing a computerized system dashboard, selecting, by a reading teacher or reading assessment administrator, a literature title and user completion date;
said computerized system sending said reading teacher or reading administrator selected literature title and completion date to one or more users;
receiving, by a computerized reading application of said computerized system, from a user device, recordings of a user's reading aloud which allow the computerized reading application to precisely locate a user's reading position in said selected literature title;
responsive to said received recordings of the user reading aloud, receiving the user's answers to one or more comprehension questions directed specifically at the most recently read portion of said assigned literature title;
analyzing, via an analysis engine, the received user's answers to derive reading performance metrics including but not limited to reading stamina, reading velocity, comprehension, vocabulary skill, and expression; and
assessing, via an assessment engine, the analyzed received user's data in comparison with preassigned text data to arrive at a running reading fluency level for the reader.

2. The method of claim 1 further including the steps of:
assigning, from an administrator device, an assigned text for the user to read;
processing, via a processor, the assigned text into individual reading assignments; and
tracking user progress in reading the individual reading assignments.

3. The method of claim 1, wherein the step of assessing further includes identifying potential dyslexia by comparing analyzed user data to expected metrics.

4. A system for assessing a user's reading ability, the system comprising:
a reading assessment tool having a database and a processor; and
a user device having a microphone and a network connection, wherein the user device records with the microphone a user reading from a text, connects to the reading assessment tool over a network via the network connection, transfers the recording to the database; and wherein the reading assessment tool processes the recording with the processor to arrive at an assessed reading ability associated with the user.

5. A method for assessing a user's reading ability using a computerized system, the method comprising:
utilizing a computerized system dashboard, selecting, by a reading teacher or reading assessment administrator, a literature title and user completion date;
said computerized system sending said teacher or administrator selected literature title and completion date to one or more users;
after the act of said computerized system sending the selected literature title to said one or more users and in response to said user completion date selected by said reading teacher or reading assessment administrator, said computerized system prompting one or more users to read aloud the reading teacher or reading assessment administrator selected literature title;
receiving, by said computerized system, from at least one user device, recordings of the user reading aloud said selected literature title,
utilizing said received user recording of the user reading aloud said selected literature title, said computerized system precisely locating a reading location in said selected literature title;
responsive to said received recordings of the user reading aloud, receiving the user's answers to one or more reading comprehension questions directed specifically at the most recently read portion of the selected literature title;
analyzing, using an analysis engine of said computerized system, the received user's answers to said comprehension questions to compute user reading performance metrics including but not limited to reading stamina, reading velocity, reading comprehension, vocabulary skill and expression; and
assessing, via said assessment engine, the analyzed received user's data in comparison with preassigned text data to arrive at a running reading fluency level for the user.
